(19) United States
(12) Patent Application Publication
(10) Pub. No.: US 2003/0024960 A1
(43) Pub. Date: Feb. 6, 2003

(54) Portable container

(76) Inventors: Mark Joseph Greenstein, Montreal West (CA); Melvin S. Mogil, Toronto (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/933,874

(22) Filed: Aug. 22, 2001

(30) Foreign Application Priority Data
Jul. 31, 2001 (CA) 2,354,505

(51) Int. Cl. A45F 4/02; B60R 7/00; B60R 9/00; A45F 4/00; A45C 15/00; A45F 3/02; A45F 3/04

(52) U.S. Cl. 224/153; 224/578; 224/580; 224/585; 224/608; 224/627; 224/645; 224/409

(57) ABSTRACT

A portable container in the form of a knapsack having a soft-sided wall structure, a bottom portion and an upwardly extending wall adjoining the bottom portion. The bottom portion and the upwardly extending wall co-operate to define a chamber therewithin. Strapping is mounted to the front portion to permit the knapsack to be carried on a person's back. A receptacle is mounted to the upwardly extending wall and extends at least partially inwardly of the upwardly extending wall relative to the chamber. The receptacle has an insulated wall member and an externally accessible closure member permitting access to objects in the receptacle.

### FIELD OF THE INVENTION

This invention relates to the field of portable containers.

### BACKGROUND OF THE INVENTION

Small children are often taken on trips such as to the park or to the store. It is common for parents to take a multi-purpose bag (also known as a diaper bag or a baby bag) along on these journeys. Typically the bag will be used for carrying extra diapers, a foldable change pad, wipes, creams, Tempra™, Anbesol™, drinking boxes, a bottle of juice, a snack, extra clothing and other similar items. If the day is warm, the bag is used as a receptacle for sweaters, hats, mitts, and other objects of clothing removed as the children become hot. As a child gets older, the diaper bag may no longer be used for diapers, but merely as a convenient carry-all. While portable bags come in many forms, the most common type of carry-all diaper bag has the general form of a satchel with a pair of handles on either side. Another, less common type of baby bag resembles a back pack.

When a stroller is used, the bag may still be needed. If the bag is placed in the stroller, it may impede the child from sitting or lying down. The bag may be malodorous. The bag may hold the child's bottles of juice or milk, and if the child wants to get at the juice or milk too soon, it would be desirable to keep the bag out of reach of the child. The bag may take up space in the stroller that could better be occupied by groceries or library books or other objects. Many strollers have underseat racks that may, at first, seem suitable for the purpose, but generally prove to be too small in practice as a stuffed diaper bag may not necessarily fit well into the relatively constricted space available.

Another alternative is to carry the bag in one hand while pushing the stroller with the other. However, pushing a stroller with one hand is not necessarily a simple skill, particularly through slush, gravel or sand, with a child who is too tired to walk any further (hence the primary need for the stroller). It may also require significant lower arm and wrist strength if, for example, a sidewalk or pathway has anything more than a modest transverse drainage slope.

One alternative is to carry the baby bag on one shoulder while pushing the stroller with two hands. This may allow better steering. However, diaper bags are often made of a Nylon™ or other washable fabric material, and may tend to slide relatively easily, and exasperatingly frequently, off one's shoulder while pushing. Re-adjusting the bag on one's shoulder for seemingly the hundredth time can be a test of patience. Alternatively, the handle of the bag may begin to dig into the shoulder. The day may be either uncomfortably warm, or rainy, cold and miserable. The child in the stroller may be restless, or irritable, or for some other reason reluctant to remain confined in the stroller. The bag may be stuffed full of odds and ends, such that its weight seems to increase with each additional step. A trip that might originally have had an appeal as a delightful short outing on foot in the fresh air may take on a longer, seemingly interminable aspect. The journey may become a rather trying test of endurance and character.

As another alternative, carrying the bag on one's back, like a knapsack, has the advantage of leaving two hands free for pushing the stroller. Still, the weight of the bag may become tiring after a while, particularly if the bag contains bottles of milk or juice or both. In addition, access to the bag may not be overly convenient. That is, it may often be inconvenient to place the straps of a backpack over both shoulders as such an arrangement does not allow for easy access to the bag when desired. For example, it is not uncommon to find that, seemingly, each time the bag is hoisted into place on one's back, no sooner is the bag settled in place than the child wants something else out of the bag. The inconvenience of a knapsack is heightened in the cooler months, as use of a knapsack over a winter coat may tend to be cumbersome and uncomfortable after a while.

Further alternatives may be considered. The stroller handle may be used as a bag carrying location. Stroller handles are often made by forming a bar into a U-shape, with the legs of the U angled forwardly and downwardly. A hand grip, or grips, may be mounted to the handle. By suspending the bag from the stroller handle, the stroller can be pushed without carrying the weight of the bag, and without having the bag either dig into one's shoulder or slide down one's arm. The bag is out of the reach of the child, in a well ventilated location, and in a relatively convenient location for access as needed.

However, typical diaper bag handles may not always tend to fit well over the handles of a stroller. They may not have a broad enough heft to grasp the handle, and so slip off, or they may slip down the handle such that the bottom of the bag may tend to drag on the ground. A knapsack mounted to the handle may hang at an awkward angle, because the mounting points for the knapsack straps are at the top center and bottom corners of the front of the pack. When slung on a stroller handle, the knapsack may tend either to scrape the ground, or to interfere with walking when the stroller is being pushed. It would be advantageous to have a bag that can be carried over the shoulder, or like a satchel as may be convenient, but also having mountings by which the bag can be attached to the stroller. In particular, it would be advantageous to mount the bag to the crossbar portion of the handle of the stroller using fittings that may tend not to slide down the handle.

Furthermore, at present it is not customary for diaper bags to be equipped with insulated bottle holding compartments. However, on a rather lengthy outing, such as an all day outing to the zoo or to the museum it may be difficult to maintain a drink, such as milk, cool until lunchtime. It would be advantageous to provide an insulated compartment for this purpose. It may also be advantageous to have the compartment lie within the profile of the main envelope of the bag, such that it may be less likely to knock into other objects.

It may also be advantageous to provide an external pouch, or pocket, or receptacle suitable for receiving a juice bottle that has already been partially opened, or that may not have as great a need to remain insulated, or that one may simply wish to be somewhat more accessible at will than a bottle carried within, for example, a zippered enclosure.

Just as it may be advantageous to have an insulated container in the bag, it may be advantageous to have a removable, washable soother holder mounted outside the bag. That is, if a wet soother is carried outside the bag, it may tend to become filthy. If a wet soother is carried inside the bag, it may tend to moisten adjacent objects undesirably, and may still become filthy. If a soother is carried in a dedicated compartment, that compartment may begin to smell. As such, a removable, washable auxiliary compartment for a soother may be a desirable adjunct to a baby bag.

Accordingly, there is a need for an improved diaper bag.

### SUMMARY OF THE INVENTION

In an aspect of the invention there is a knapsack having a soft-sided wall structure, a bottom portion and an upwardly extending wall adjoining the bottom portion. The bottom portion and the upwardly extending wall co-operate to define a chamber therewithin. The wall structure has an upper region and an opening defined in the upper region by which to obtain access to the chamber. The upwardly extending wall has a front portion, a rear portion and left and right hand side portions. The wall structure has a height, a width from left to right, and a front to rear dimension. The width is greater than the front to rear dimension, and the height is greater than the width. Strapping is mounted to the front portion to permit the knapsack to be carried on a person's back. A receptacle is mounted to the wall structure. The receptacle extends at least partially inwardly of one of the side portions relative to the chamber. The receptacle has an insulated wall member. The receptacle has an externally accessible closure member permitting access to objects in the receptacle independently of the opening defined in the upper region of the upwardly extending wall.

In an additional feature of that aspect of the invention, the receptacle has a base, a height measured upwardly from the base, a width, and a depth measured inwardly of the one of the side portions of which the receptacle extends inwardly. The height is greater than either the width or the depth.

In another additional feature, the receptacle lies inwardly of an opening formed in one of the side portions. The closure member of the receptacle is a flap movable to a closed position obstructing the opening.

In still another additional feature, the closure member is a flap having a lower edge hingedly mounted to the wall structure, and peripheral attachments are operable to mate the flap with the opening in the side portion.

In yet another additional feature, the receptacle is deformable to permit objects in the chamber to displace portions of the receptacle when the receptacle is unoccupied.

In still yet another additional feature, the wall structure has an enclosure envelope profile, and the receptacle falls within the profile.

In a further additional feature, the front portion of the upwardly extending wall has an upper margin, a lower margin, a left margin and a right margin. The strapping includes a pair of first and second straps, each having a first attachment location adjacent to the upper margin of the front portion. Each of the first and second straps has a second attachment in a lower region of the front portion adjacent the left and right hand margins, respectively. Most of the receptacle lies laterally inboard of one of the lower attachment fittings.

In another additional feature, the rear portion has an auxiliary wall structure mounted thereto. The auxiliary wall structure defines a second chamber therewithin. The auxiliary wall structure has a closure member operable to control access to the second chamber.

In still another additional feature, the auxiliary wall structure is a full width structure extending between the left and right hand portions.

In yet another additional feature, the externally accessible closure member is mounted to one of the side portions of the upwardly extending wall.

In a further additional feature, a washable auxiliary compartment is attachable by a quick release fitting to the soft-sided wall structure.

In another aspect of the invention, there is a knapsack having a soft-sided wall structure having a bottom portion and an upwardly extending wall adjoining the bottom portion. The bottom portion and the upwardly extending wall co-operate to define a chamber therewithin. The wall structure has an upper region and an opening defined in the upper region by which to obtain access to the chamber. The upwardly extending wall has a front portion, a rear portion and left and right hand side portions. The wall structure has height, a width from left to right, and a front to rear dimension. The width is greater than the front to rear dimension, and the height is greater than the width. Strapping is mounted to the front portion to permit the knapsack to be carried on a person's back. An insulated receptacle is mounted to the wall structure. The receptacle extends at least partially inwardly of one of the side portions relative to the chamber. The receptacle has at least one insulated wall member. The insulated receptacle has a base, a height measured upwardly from the base, a width, and a depth measured inwardly of the one of the side portions of which the receptacle extends inwardly. The height is greater than either the width or the depth. The receptacle has a closure member permitting access to objects in the receptacle structure.

In another aspect of the invention, there is a knapsack having a wall structure having a bottom portion and a sidewall portion standing upwardly of the bottom portion. The sidewall portion and the bottom co-operate to define an internal storage compartment. The sidewall portion has an opening defined in an upper region thereof by which to obtain access to the internal compartment. The wall structure has a closure member attached thereto. The closure member is movable to a position obstructing the opening. The sidewall structure has a leading portion, and a trailing portion. A pair of first and second straps is mounted to the leading portion to facilitate carriage of the knapsack next to a person's back. The straps each have an upper end mounted to an upper region of the leading portion, and a lower end mounted to a lower region of the leading portion. The upper ends of the respective straps are mounted closer together than the respective lower ends. A pair of first and second releasable loops is mounted to the upper region of the leading portion. The loops are operable to wrap about an adjacent object, and the loops are securable to permit the knapsack to be suspended therefrom.

In an additional feature of that aspect of the invention, the knapsack includes an insulated receptacle mounted to extend at least partially within the wall structure.

In another additional feature, the sidewall structure has left and right hand side portions, and the insulated receptacle is externally accessible through one of the side portions.

In still another additional feature, the insulated receptacle is a side accessible receptacle mounted flush with the sidewall.

In yet another additional feature, the first and second loops are spaced apart and bracket the upper ends of the straps.

In still yet another additional feature, strap retainers are mounted to the leading portion and the loops are engageable with the strap retainers.

In a further additional feature, a connecting member is mounted to releasably connect the first and second straps in a region intermediate the respective upper and lower ends thereof.

In yet a further additional feature, a zipper is mounted along opposed portions of the first and second straps. The zipper is operable to cinch the opposed portions together.

In another additional feature, an externally mounted detachable wall structure defines an auxiliary chamber.

In yet another additional feature, the sidewall structure has left and right hand side portions. An insulated receptacle is mounted to extend within the wall structure. The receptacle is flush mounted with a first of the side portions and is externally accessible through an opening defined in the first side portion. The first and second loops are spaced apart and bracket the upper ends of the straps. A connecting member is mounted releasably to connect the first and second straps in a region intermediate the respective upper and lower ends thereof.

In another aspect of the invention, there is a knapsack having a soft-sided wall structure having a bottom portion and an upwardly extending wall adjoining the bottom portion. The bottom and upwardly extending wall co-operate to define a chamber therewithin. The wall structure has an upper region and an opening defined in the upper region by which to obtain access to the chamber. The upwardly extending wall has a front portion, a rear portion and left and right hand side portions. The wall structure has height, a width from left to right, and a front to rear dimension. The width is greater than the front to rear dimension, and the height is greater than the width. First strapping is mounted to the front portion to permit the knapsack to be carried on a person's back. The first strapping is attached to the front portion at upper and lower locations. The first strapping has at least a minimum length. A releasable attachment fitting is mounted to the front portion at an upper location. The releasable attachment fitting is operable to permit the releasable attachment fitting to be secured to an adjacent object and suspended therefrom.

In an additional feature of that aspect of the invention, the releasable attachment fitting includes second strapping.

In another additional feature, the first strapping has a first length. The second strapping has a second length. The second length is less than the first length.

In yet another additional feature, the releasable attachment fitting forms a closed loop.

In still another additional feature, retainers are operable to maintain the second strapping in a stored position when the second strapping is not in use.

In still yet another additional feature, the first strapping includes a first shoulder strap and a second shoulder strap. The first and second shoulder straps are releasably connected along respective portions thereof.

In a further additional feature, the first strapping has a zipper mounted to releasably connect the respective portions of the first shoulder strap and the second shoulder strap.

In still a further additional feature, the front portion has a first panel and a second panel. The first panel is mounted in front of the second panel and a pocket is located between the first and second panels.

In yet a further additional feature, the pocket is externally accessible.

In still yet a further additional feature, the front portion has a first panel and a second panel. The first panel and the second panel define a front pocket space therebetween.

In another additional feature, a front pocket is mounted within the front pocket space. The front pocket is side accessible.

In a further aspect of the invention, there is a portable container having a soft-sided wall structure having a bottom portion and an upwardly extending wall adjoining the bottom portion. The bottom and upwardly extending wall co-operate to define a chamber therewithin. The wall structure has an upper region and an opening defined in the upper region by which to obtain access to the chamber. The upwardly extending wall has a front portion, a rear portion and left and right hand side portions. The wall structure has height, a width from left to right, and a front to rear dimension. The width is greater than the front to rear dimension, and the height is greater than the width. A releasable loop is mounted to the wall structure. A carrying member is mounted to the wall structure.

In an additional feature of that aspect of the invention, first strapping is mounted to the front portion to permit the knapsack to be carried on a person's back. The first strapping is attached to the front portion at upper and lower locations. The first strapping has a length and wherein the releasable loop has a length. The length of the releasable loop is less than the length of the first strapping.

### BRIEF DESCRIPTION OF THE DRAWINGS

For a better understanding of the present invention and to show more clearly how it may be carried into effect, reference will now be made by way of example to the accompanying drawings, which show an example of an assembly embodying the principles of the present invention, and in which:

FIG. 1 shows a perspective view of an example of a portable bag in accordance with the principles of the present invention;

FIG. 2 shows a perspective view of the portable bag of FIG. 1 with the main compartment in the open position and with the insulated liner bag removed;

FIG. 3 shows a perspective view of the portable bag of FIG. 1 with the front pocket opened with an insulated liner bag removed therefrom;

FIG. 4a shows a rear perspective view of the portable bag of FIG. 1 with the shoulder straps joined together;

FIG. 4b shows a rear perspective view of the portable bag of FIG. 1 with the shoulder straps separated;

FIG. 5 shows a rear perspective view of the portable bag of FIG. 1 with the bottle compartment closed;

FIG. 6 shows a rear perspective view of the portable bag of FIG. 1 with the bottle compartment opened;

FIG. 7a shows a sectional view of the bottle compartment of FIG. 6 taken on section ‘7a-7a’ with the bottle compartment closed as in FIG. 5;

FIG. 7b shows a sectional view of the bottle compartment of FIG. 6 taken on section ‘7b-7b’ as shown in FIG. 7a;

FIG. 8 shows a perspective view of the portable bag of FIG. 1 with a bottle in the side pocket;

FIG. 9 shows a top view of the side pocket of FIG. 8 taken on section ‘9-9’;

FIG. 10 shows a front view of the upper portion of the side pocket of FIG. 8 taken on section ‘10-10’;

FIG. 11 a shows a view of the bag of FIG. 1 as mounted to the handle bar of a stroller;

FIG. 11b shows an alternate mounting of the bag of FIG. 1 to the handle bar of a stroller;

FIG. 11c shows a sectional detail of the mounting of FIG. 11b taken on section ‘11c-11c’ of FIG. 11b;

FIG. 12 shows a rear plan view of the portable bag of FIG. 1;

FIG. 13 shows a right plan view of the portable bag of FIG. 1;

FIG. 14 shows a front plan view of the portable bag of FIG. 1;

FIG. 15 shows a left plan view of the portable bag of FIG. 1;

FIG. 16 shows a top plan view of the portable bag of FIG. 1; and

FIG. 17 shows a bottom plan view of the portable bag of FIG. 1.

### DETAILED DESCRIPTION OF THE INVENTION

The description that follows, and the embodiments described therein, are provided by way of illustration of an example, or examples, of particular embodiments of the principles of the present invention. These examples are provided for the purposes of illustration, and not of limitation, of those principles and of the invention. In the description that follows, like parts are marked throughout the specification and drawings with the same respective reference numerals. The drawings are not necessarily to scale and in some instances proportions may have been exaggerated in order more clearly to depict certain features of the invention.

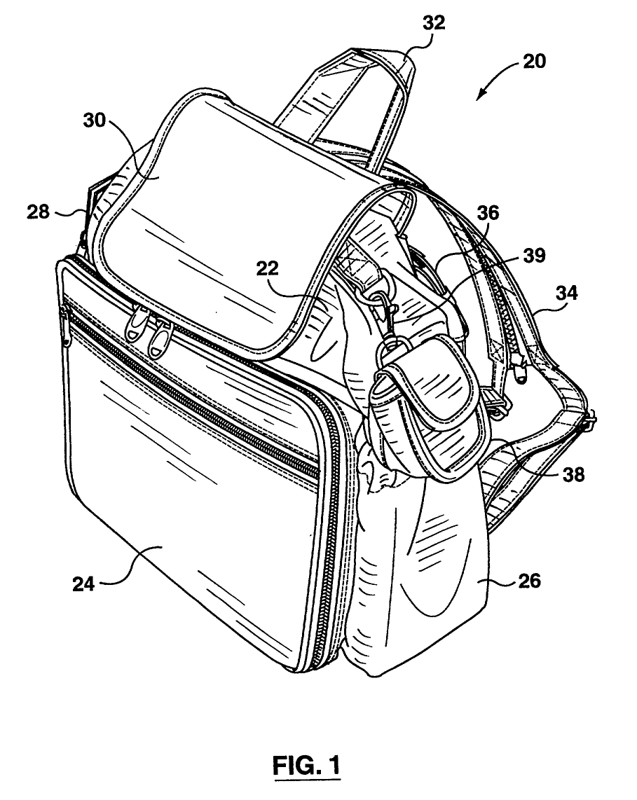

FIG. 1 shows a perspective view of a soft-sided, portable container in the nature of a knapsack identified as a diaper bag, or baby bag, 20. In terms of a frame of reference, the front portion of the illustrated embodiment of a knapsack is the portion that would lie against a wearer's back if worn as a knapsack. The rear, or rearward portion is that portion that would be trailing if a person wearing the pack were to walk frontwards. Transverse, or transversely inboard or outboard refer to orientations or distances to left and right relative to a vertical front-and-rear plane passing thorough the center of the knapsack, and are in the direction of the width of the knapsack generally. To the extent that the example described below is asymmetric, bag 20 can be made in either left-hand or right-hand versions.

Bag 20 has a main compartment 22; a first auxiliary compartment identified as main pocket assembly 24, mounted to the rearward portion of bag 20; a second auxiliary compartment, or receptacle structure, identified as open side pocket 26 mounted to the right side of bag 20; and still another compartment, or receptacle identified as bottle compartment 28, mounted to the left side of bag 20. Front pocket 24 and open side pocket 26 are external to main compartment 22, while bottle compartment 28 is recessed within main compartment 22. That is, the main wall structure of bag 20 has four upwardly extending side portions (left, right, front and rear, as noted below) that cooperate to give a generally rectangular shape when seen from above. Bottle compartment 28 is accessible through the side opening defined in the sidewall, and lies within the rectangular profile of the upstanding wall portions. As such, the bottle receptacle structure, and bottles in receptacle 28 will tend to lie inwardly, or inboard, of the plane of the left wall portion. Bag 20 has a closure, or cover member in the nature of a top flap 30; a lifting member, or fabric handle, identified as top handle 32; strapping mounted to the front portion to permit the knapsack to be carried on a person's back, identified as zippered lifting straps 34; retaining members, in the nature of additional releasable strapping for attaching bag 20 to an object such as a stroller or bicycle handle bar, identified as stroller straps 36; and an auxiliary container in the nature of a soother pouch 38 attached by a quick release fitting 39, such as may facilitate washing of pouch 38. Although compartment 28 is mounted on the left, and pocket 26 is mounted on the right, their relative positions could be reversed to place compartment 28 on the right and compartment 26 on the left.

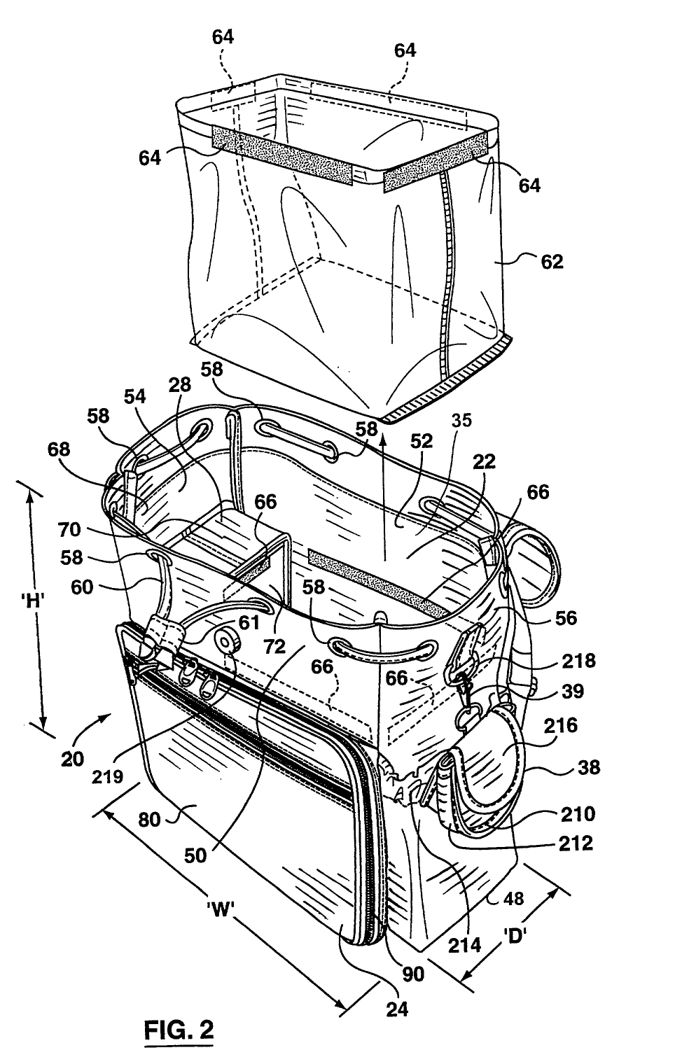

As shown at FIG. 2, the main body of diaper bag 20 is a soft-sided wall structure having an upwardly extending wall including a rear portion identified as rear wall 50; a front portion identified as front wall 52; a left hand side portion identified as left side wall 54; a right hand side portion identified as right side wall 56; and a bottom portion identified as bottom wall 48. The inner surfaces of the soft-sided wall structure cooperate to bound, and thereby to define, a chamber, namely the interior of main compartment 22 indicated generally as 35. Rear wall 50 and front wall 52 are rectangular and are approximately the same size. A single elongated rectangular panel is folded to form right side wall 56 and bottom wall 48. Left side wall 54 does not show an uninterrupted vertical face to the interior of main compartment 22 but rather has a rectangular opening giving access to the recess formed by bottle compartment 28 in its position mounted to the wall structure and protruding inwardly from the left side portion of the wall structure. Left side wall 54 has an upper left side wall portion 68, a bottle compartment top surface 70 and a bottle compartment side surface 72. Adjacent wall portions are stitched to one another. Each of the walls may include stiffening members or may be formed from a relatively stiff material to allow diaper bag 20 to maintain its general shape. Bag 20 has a height ‘H’, measured from bottom to top, a width ‘W’, measured transversely (that is, from the right hand side to the left hands side) and a front-to-rear dimension ‘D’ as measured from the front wall to the rear wall of the soft sided wall structure The width is greater than the front to rear measurement, and the height is greater than the width.

The upper region of the wall structure has an opening defined by the respective upper margins, or upper portions, of walls 50, 52, 54 and 56. These margins have grommetted drawstring holes 58 through which a drawstring 60 is passed. In the open configuration shown in FIG. 2, the upper ends of walls 50, 52, 54 and 56 are spread apart from one another to yield an accessway to main compartment 22, the accessway having a generally rectangular cross-sectional shape. When drawstring 60 is pulled, drawstring holes 58 are brought together and main compartment 22 may be closed as illustrated in the closed position shown in FIG. 1. The ends of drawstring 60 are passed through a closure securement means in the nature of a fabric yoke 61, the friction between yoke 61 and drawstring 60 tending to hold the upper margins in the closed position.

In the example illustrated, main compartment 22 is provided with an insulated liner bag 62 which is adapted to fit snugly within main compartment 22. As shown in FIG. 2, liner bag 62 has generally rectangular shaped sides and is the same height as bottle compartment 28. The upper portion of liner bag 62 is provided with hook and loop strips 64 which mate with hook and loop strips 66 mounted on the inner surface of main compartment walls 50, 52, 54 and 56.

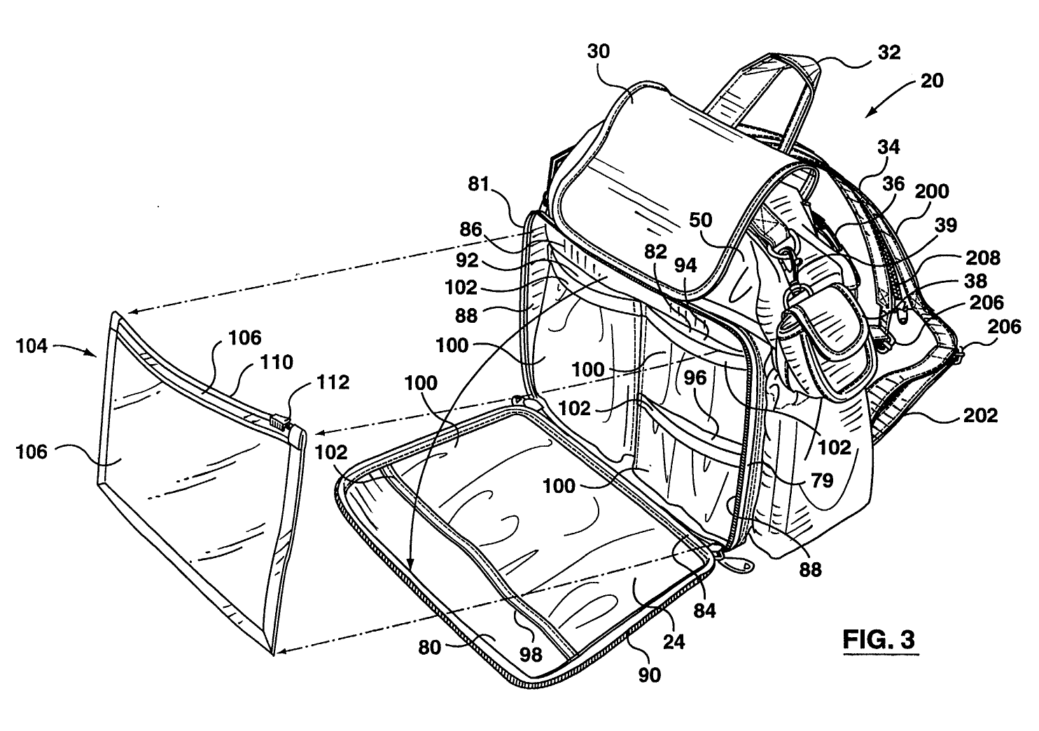

FIG. 3 shows main pocket assembly 24 in the open position. Main pocket assembly 24 extends across the full width ‘W’ of bag 20 between left side wall 54 and right side wall 56. Main pocket assembly 24 has a generally rectangular peripheral wall 79 attached along its proximal edge by a stitched peripheral hem to the rear, i.e., outwardly facing surface, of rear wall 50. Peripheral wall 79 stands generally outwardly of rear wall 50, and has a generally rectangular distal edge 81. A closure member, identified as front flap 80, of corresponding generally rectangular plan form is pivotally mounted by a fabric hinge along its lower edge to the lower edge portion of the distal edge of wall 79.

That portion of rear wall 50 lying within the bounds of peripheral wall 79 is identified as rear pocket wall 82 (being the rear wall of the enclosure formed by pocket assembly 24). The lower portion of peripheral 79 is identified as pocket base 84, the upper portion as pocket top 86, and the respective left and right hand sides as pocket sides 88. The remaining three sides, namely the top, left and right hand sides of flap 80 and peripheral wall 79 share opposite, mating portions of a releasable closure member in the nature of a zipper, 90, that is moveable between a closed position as shown in FIG. 1, and the open position shown in FIG. 3. As such, zipper 90 connects the periphery of front flap 80 to pocket top 86 and pocket sides 88.

Rear pocket wall 82 has three pouch receptacles identified as pockets 92, 94 and 96. Front flap 80 has a full width pouch receptacle identified as pocket 98. Each of these pockets is of a similar construction. Pocket 92 covers the left half of rear pocket wall 80 while pocket 94 covers the top right quarter of rear pocket wall 82 and pocket 96 covers the right bottom corner of rear pocket wall 82. Pocket 98 covers most of front flap 80. Pockets 92, 94, 96 and 98 are defined by the rear pocket wall 82 (or in the case of pocket 98 by the inner surface of front flap 80) and liner panels 100. Liner panels 100 are generally rectangular and are stitched to rear pocket wall 82 along three sides while remaining open to the top. The top edge of liner panels 100 are each stitched to an elastic 102, the ends of which are affixed to rear pocket wall 82 (or in the case of pocket 98 to front flap 80). Resilient biasing members in the nature of elastics 102 are provided so that the openings for pockets 92, 94, 96 and 98 may tend to be constricted.

FIG. 3 also shows a liner bag 104, which is made up of two rectangular panels 106 stitched to one another along the bottom and side edges. The top edges 110 are sealable with a sliding fastener 112. Liner bag 104 fits within front pocket 24 without folding.

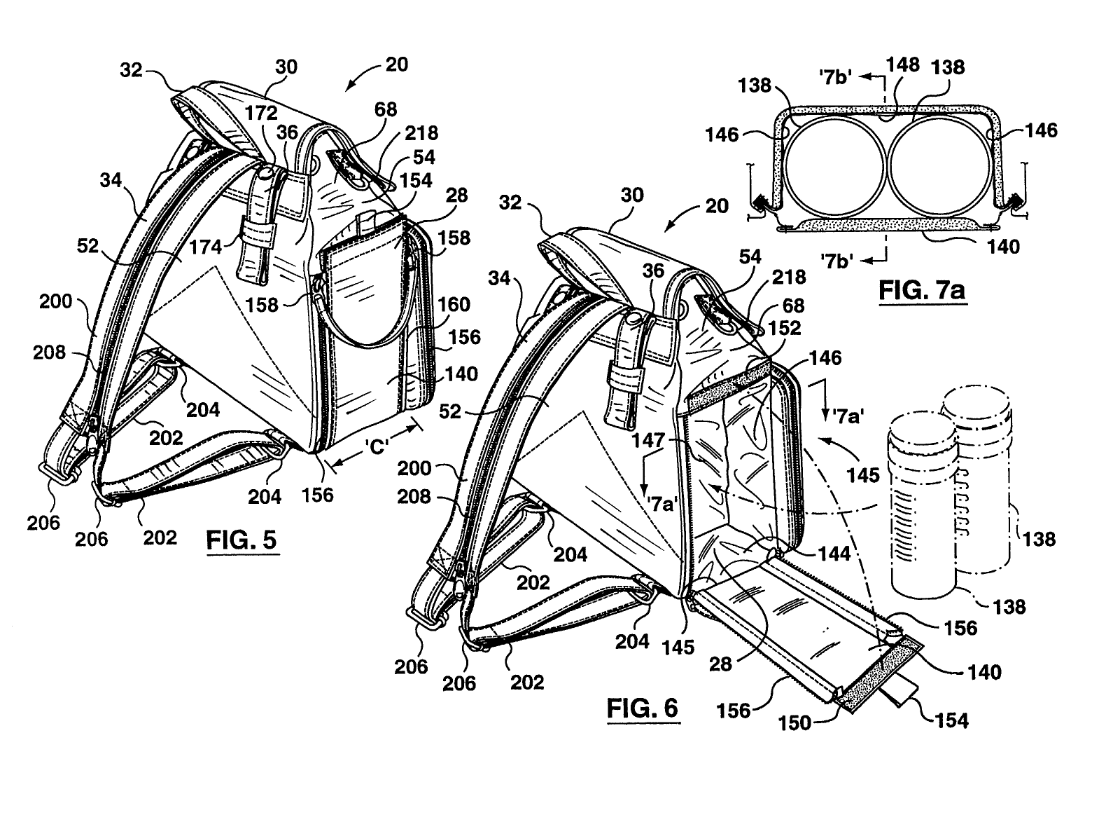

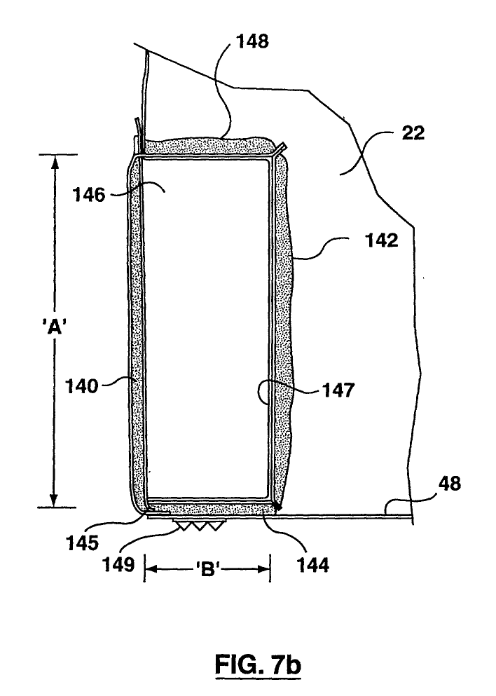

FIGS. 5, 6, 7a and 7b show bottle compartment 28 in greater detail. In discussing bottle compartment 28, the direction of the rearmost portions of bottle compartment 28 will be towards the interior of main compartment 22 while the front portions will lie along, or be substantially flush with, the exterior of the main bag compartment 22. That is, inasmuch as left side wall 54 is generally planar, the front of compartment 28 lies generally in the plane of left side wall 54.

A rectangular opening, that is taller than wide and indicated generally as 145 is defined in side wall 54 to permit access to compartment 28 independently of opening 35. Bottle compartment 28 has a closure member in the nature of a front flap 140, a top compartment wall 148, a bottom compartment wall 144, side compartment walls 146, and a rear compartment wall 142. As such, the walls of bottle compartment 28 are each generally rectangular in shape and co-operate to define an enclosed space. Walls 142, 144, 146 and 148 are collapsible such that when bottle compartment 28 is not occupied, a greater amount of material can be stuffed into the main compartment.

Front flap 140 may be pulled away from main bag compartment 22 to open bottle compartment 28 and to allow bottles 138 to be placed into, and removed from, bottle compartment 28. Front flap 140 is stitched to bottom compartment wall 144 to form a fabric hinge 145. Along the upper most edge of front flap 140 is a hook and loop strip 150 for releasably mating with a corresponding hook and loop strip 152 at the bottom edge of side wall 54. Affixed to the uppermost edge is a pull tab in the nature of a flap handle 154. Front flap 140 is releasably affixed to side compartment walls 146 by zippers 156 having sliders 158. A yoke in the nature of a zipper strap 160 extends between sliders 158.

FIG. 5 shows the bottle compartment 28 in the closed position. To open bottle compartment 28, the user may pull zipper strap 160 downward to open zippers 156 and pull on flap handle 154 to separate hook and loop fasteners 150 and 152 from one another, opening bottle compartment 28 as shown in FIG. 6. In the example illustrated, bottle compartment 28 can accommodate two standard 8 oz. baby bottles 138. Front flap 140, and compartment walls 142, 144, 146 and 148 are all provided with insulating material such as a ⅜″ thick layer of closed cell insulating foam and may tend to permit the user to maintain the liquid in bottles 138 at a lower (or possibly warmer) temperature than ambient for a longer period of time than might otherwise be the case. Each of front flap 140, and compartment walls 142, 144, 146 and 148 have a reflective surface facing inwardly relative to the enclosed space of compartment 28. Compartment 28 has a clear vinyl liner 147 overlying, and conforming generally to, the reflective inwardly facing surfaces of compartment walls 142, 144, 146 and 148. It is intended that liner 147 be generally water impermeable to discourage leaks or drips from migrating through the seams of the bag, and that liner 147 provide a surface that can be relatively easily cleaned. Compartment 28 has a height ‘A’ measured upwardly from the base, namely bottom wall 144, to the top wall 148, and a depth ‘B’ measured inwardly from closure flap 140 to the inner, or rear wall 142, and a width ‘C’ measured across the opening. As can be seen, ‘C’ is greater than ‘B’, and ‘A’ is greater than either ‘B’ or ‘C’, such that a container that is taller than wide, or, as suggested by item 138, two containers that are taller than wide, such as drink bottles, may tend to stand upright within compartment 28. This may be advantageous with baby bottles, as baby bottle nipples may sometimes have a tendency to drip. It is preferred that the aspect ratio of height ‘A’ to depth ‘B’ be greater than 2:1, and preferably about 2.5:1 to 3:1. Bottom wall 48 has four feet 149, mounted at each corner such that when bag 20 is placed on the ground, bag 20 may tend to stand upright, and may tend to maintain the upright orientation of bottles carried in compartment 28.

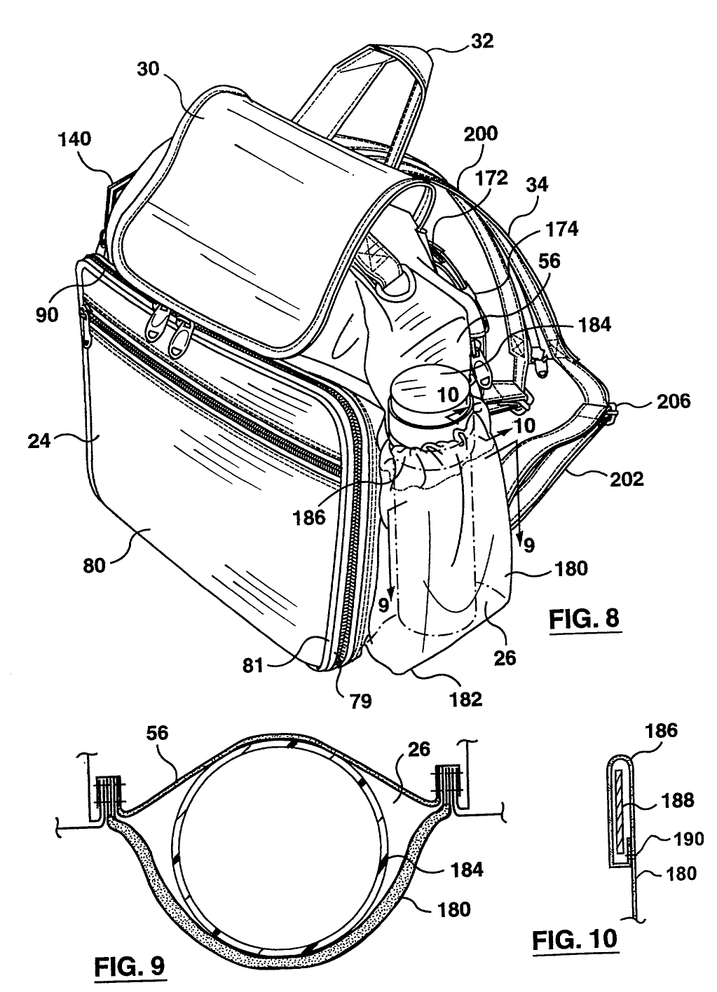

FIGS. 8, 9 and 10 show open side pocket 26 in greater detail. Pocket 26 is a receptacle defined by right side wall 56 and by pocket panel 180. Pocket panel 180 is affixed to the side and lower edges of right side wall 56. Pocket panel 180 is folded to create a flat base 182 on which a bottle 184 may rest. Pocket panel 180 is optionally formed as shown, from an insulating material which tends to assist in maintaining bottle 184 at a lower (or possibly warmer) temperature than ambient.

Upper edge 186 of pocket panel 180 is folded to surround a biasing member in the nature of an elastic 188. Upper edge 186 is stitched to itself at seam 190 as shown in FIG. 10. Elastic 188 serves to constrict the opening of pocket 26. This pocket may tend to be suitable for receiving and accommodating baby bottle 184 and has the advantage of having an external closure permitting relatively easy access. Any extra bottles not in use may be stored in bottle compartment 28.

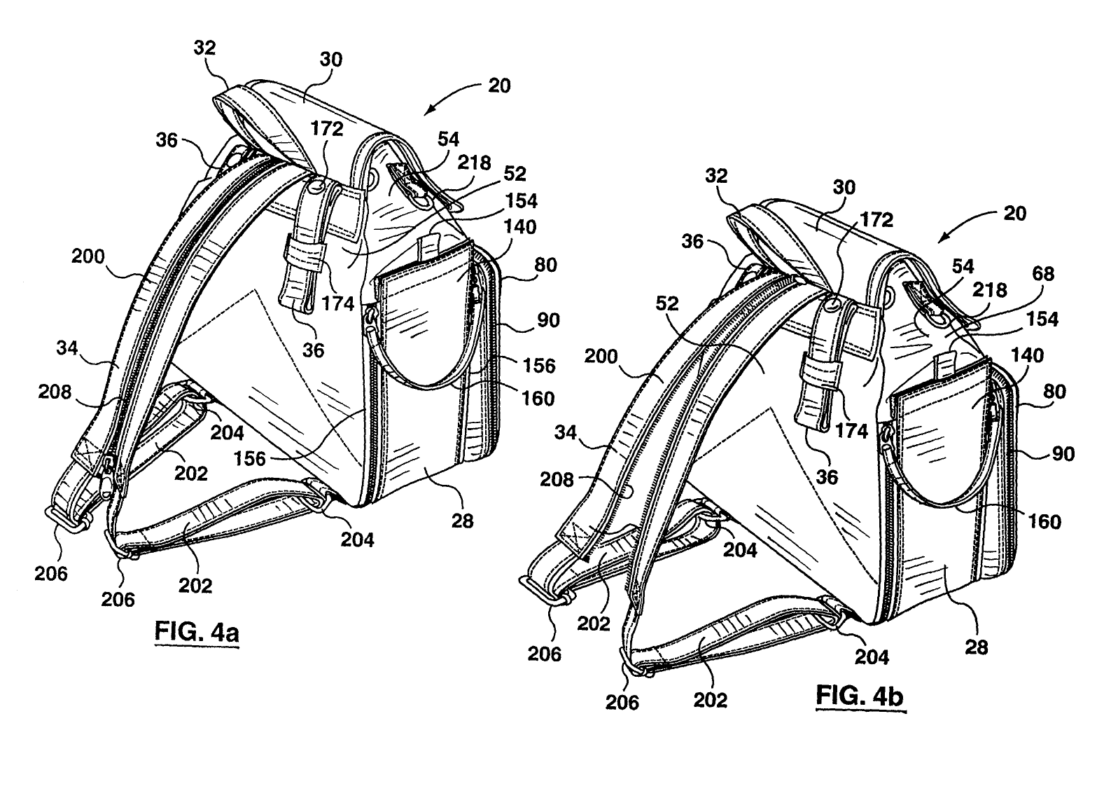

As well, bag 20 has attachment fittings or strapping in the nature of the pair of left and right hand stroller straps 36, mounted to either side of (i.e., bracketing) the top anchoring location of lifting straps 34. Straps 36 are shown in greater detail in FIGS. 4a and 4b. Stroller straps 36 are fabric loops affixed to the upper portion of front wall 52 and are closed by releasable attachments in the nature of loop snaps 172. One portion, typically the male portion, of each of loop snaps 172 is located proximate to the seam between stroller straps 36 and rear wall 56. The other portion, typically the female portion of each of loop snaps 172 is located a girth distance away on each of straps 36. The girth distance, or arc length, of straps 36 between the mating male and female portions of snaps 172 is significantly less than the shortest length of the lifting straps 36 when adjusted to their minimum length, or girth. Preferably, the girth, or arc length of straps 36 between the male and female of snaps 172 portions is 8 inches or less.

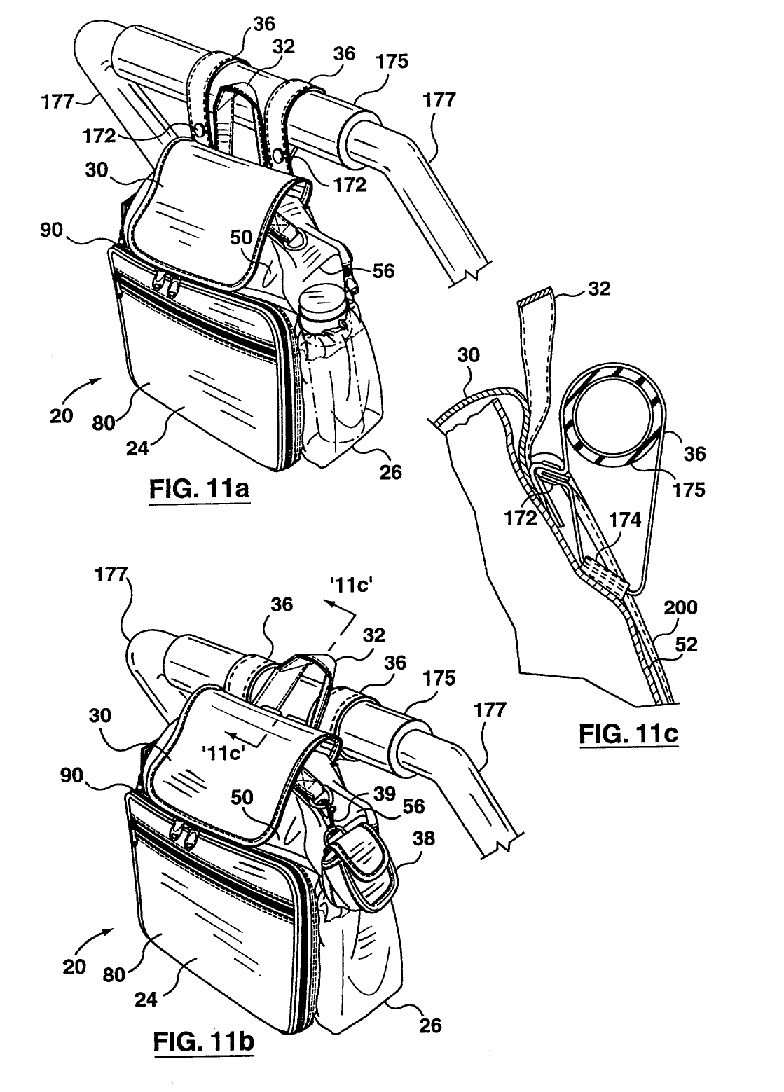

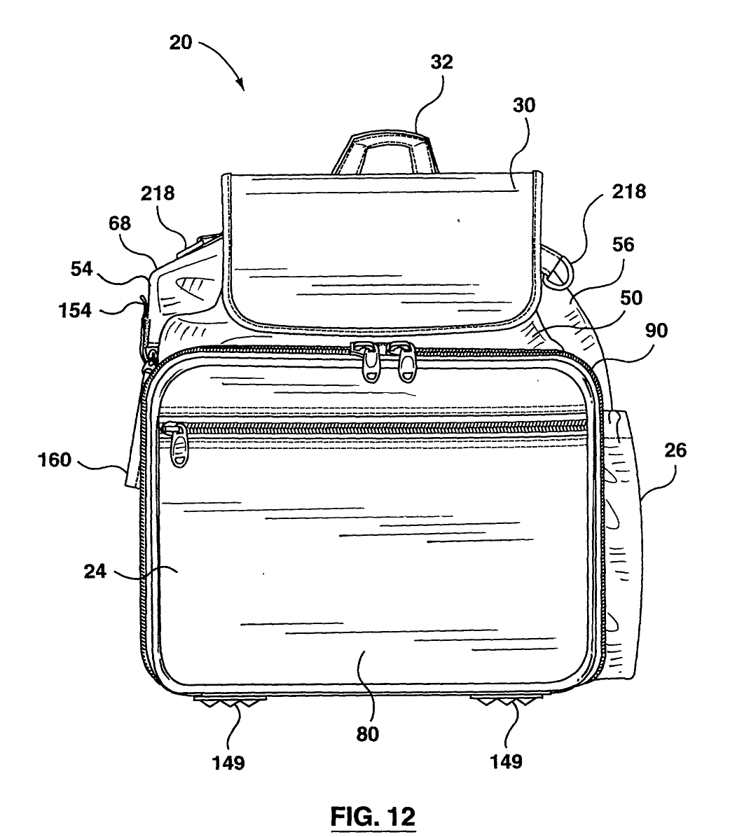

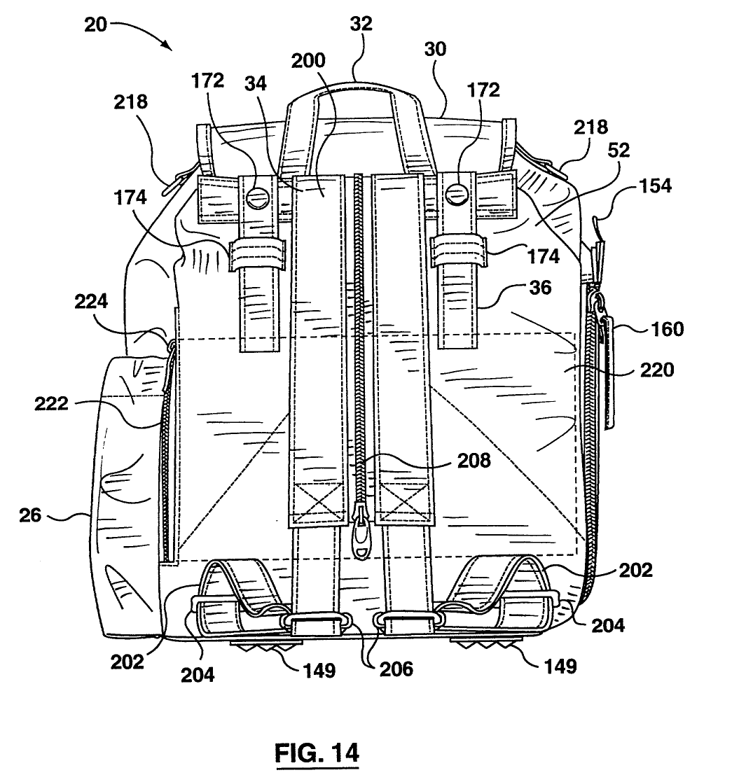

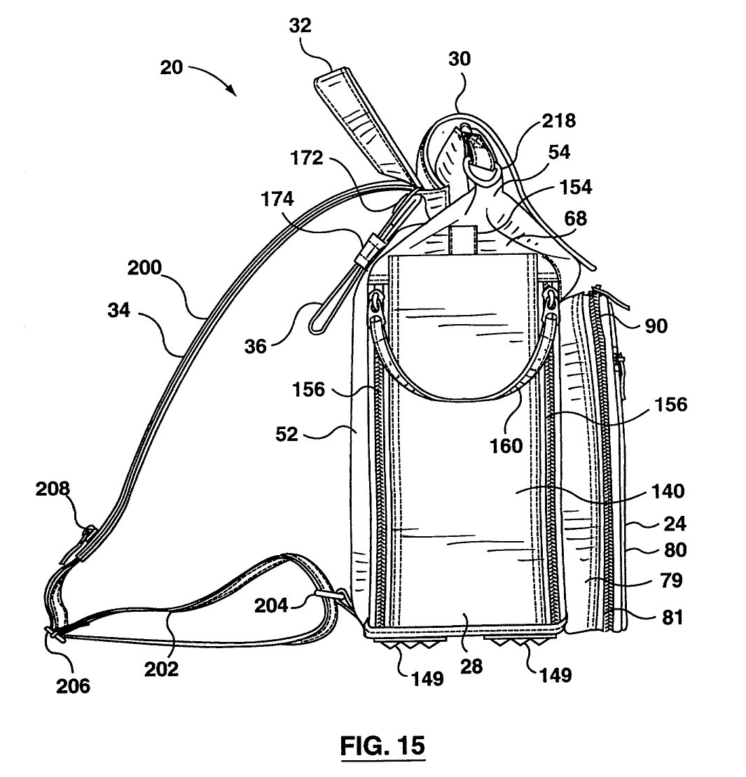

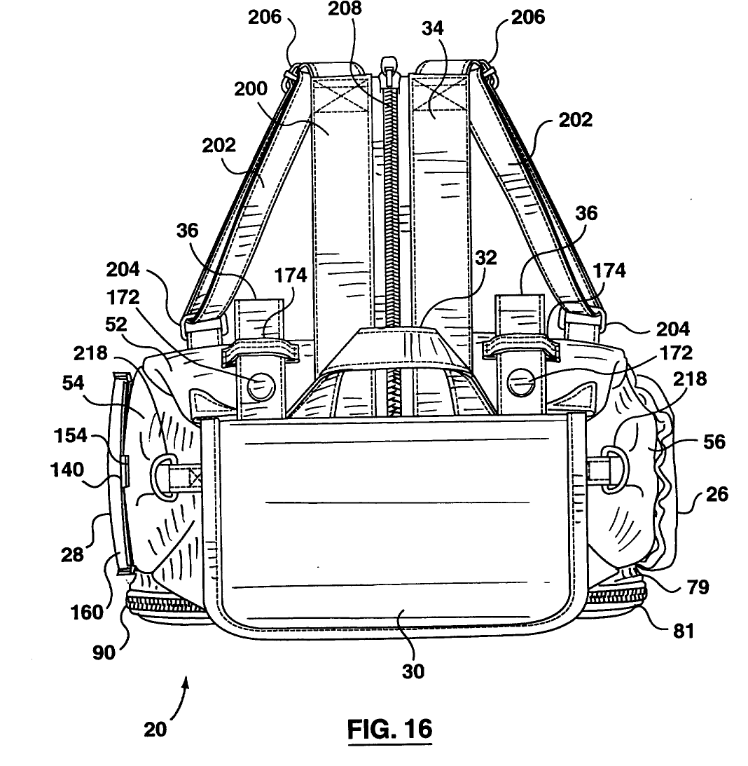

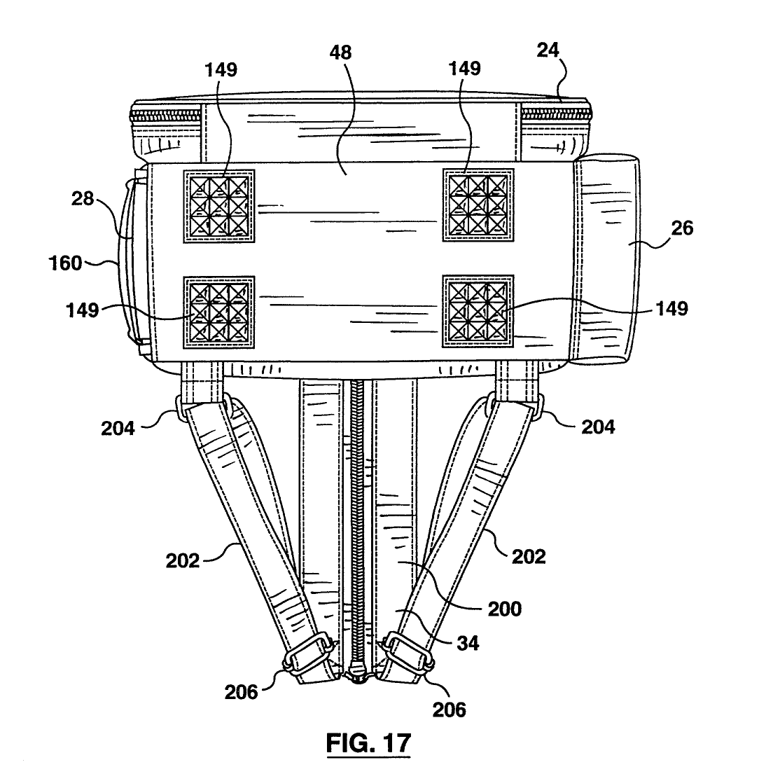

As shown in FIGS. 4a, 4b and 14, when stroller straps 36 are not required, they may be kept in a folded position, close to the bag, by feeding straps 36 through strap retaining members or holders in the nature of cleats, or keepers 174 affixed to front wall 52. In use, loop snaps 172 are opened and the loop straps may be wound or folded over, for example, a horizontal bar 175 of a baby stroller or bicycle handlebar, or similar device and fed through keepers 174, as shown in FIGS. 11b and 11c. Loop snaps 172 may then be closed about horizontal bar 175 of the baby stroller allowing bag 20 to hang from the horizontal bar 175 of the baby stroller. Stroller straps 36 are placed relatively close together and fasten to form relatively small loops to discourage straps 36 from migrating easily along horizontal bar 175 and then slipping down adjoining inclined side members 177 of the handle of the stroller. However, straps 36 are spaced modestly apart transversely to encourage bag 20 to remain stable when hanging from the stroller. That is, by being spaced apart, straps 36 may tend to inhibit rotational spinning or twisting of bag 20 about a vertical axis relative to stroller cross-bar 175, and may also tend to discourage, reduce or limit, lateral swaying of bag 20 relative to inclined side members 177 of the stroller handle as the stroller is being pushed. Straps 36 may be spaced apart laterally in the range of 4 to 8 inches, and preferably on about 5 inch centers. The portions of straps 36 furthest from main compartment 22, when spread apart from one another, reach a maximum distance from one another of 8 to 12 inches. Given that most horizontal bars of baby strollers are greater than 12 inches in length, this maximum distance between the distal portions of straps 36 permits straps 36 to ride on the stroller handle bar while the handle is being gripped by two hands laterally outboard of straps 36. This stance may tend to prevent stroller straps 36 from sliding down the struts adjacent the ends of a horizontal baby stroller bar when stroller straps 36 are snapped in the looped position.

In an alternative use, straps 36 can also be attached to a cross-bar without passing through keepers 174, as illustrated in FIG. 11a. In this configuration the strap is not as tightly choked, and, consequently bag 20 may tend to hang somewhat lower, and looser, relative to bar 175 than in the mounting configuration illustrated in FIG. 11b.

FIGS. 4a and 4b also show strapping in the nature of shoulder straps 34 in greater detail. Each of shoulder straps 34 has an upper strap section 200 and a lower strap section 202. Upper strap sections 200 each have an upper end anchored by stitching between the top edge of front wall 52 and a lateral reinforcement web. The upper ends of strap sections 200 are located adjacent to one another at the top center of wall 52, between stroller straps 36. Upper strap sections 200 are stitched at their lower end to lower strap sections 202. Lower strap sections 202 are looped around strap anchor fittings, in the nature of loops 204 and end at strap adjustment fittings 206, such as permit the length, and hence the girth, of straps 34 to be adjusted to suit a wearer. Loops 204 are affixed to the lower edge of front wall 52 and are spaced apart from one another at the lower outboard corners of front wall 52, to allow the user to wear diaper bag 20 on the back in the manner of a knapsack if so desired.

Mating halves of a guided track fastener in the nature of a zipper 208 are mounted to the respective laterally inward margins of upper strap sections 200 as shown in FIGS. 4a and 4b. Zipper 208 acts as a connecting, or binding, or cinching device. That is, zipper 208 is movable to an open, or disengaged position as shown in FIG. 4b, and an engaged, cinched, zipped, or closed position as shown in FIG. 4a. When zipper 208 is undone, as shown in FIG. 4a, the shoulder straps may be worn over each shoulder like a standard backpack. When upper strap sections 200 are connected or cinched, the joined strap sections may be worn over a single shoulder, and as zipped together, may have less tendency to slip off a wearer's shoulder than might otherwise be the case.

Top flap 30 is affixed along one edge to the upper edge of front wall 52 as shown in FIG. 4a. When drawstring 60 is pulled together and main compartment 22 is closed, top flap 30 may be folded over the top portion of main compartment 22 to keep out rain and to keep any items from falling out of main compartment 22. Top flap 30 may be affixed to magnetic latch 219 of which one portion (shown on FIG. 2), whether male or female, (North or South), is mounted on rear wall 50 which is releasably engageable with another, mating latch portion, (not shown) mounted on the bottom surface of top flap 30.

Top handle 32 is a strap affixed at each end to the upper portion of front wall 52 as shown in FIG. 4a. Top handle 32 may be grasped by the user to facilitate the carrying of bag 20 in the general manner of a satchel or hand bag.

A washable auxiliary compartment in the nature of soother pouch 38 is releasably connected to bag 20 as shown in FIGS. 1 and 2. Pouch 38 has a soft-walled, washable structure defining a chamber in which to accommodate a baby soother or pacifier. In discussing soother pouch 38, the direction of the frontmost portions of soother pouch 38 are the portion to which the top flap attaches to close the pouch. The soft-wall structure is made up of a front wall 210, a rear wall 214 and a side wall 212. Front wall 210 and rear wall 214 are generally rectangularly shaped with curved corners while side wall 212 has an elongated rectangular shape. Front wall 210 and rear wall 214 are each stitched along three edges to the elongated opposite edges of side wall 212. The upper edges of front wall 210 and rear wall 214 and the exposed edges of side wall 212 define an opening through which a soother may be placed into the soother pouch chamber. A top flap 216 is stitched near the upper portion of rear wall 214 and extends over the opening of the soother pouch chamber. Mating hook and loop straps (not shown) are affixed to outside of front wall 210 and to the inside of top flap 216 to allow top flap 216 to cover the opening of the soother pouch chamber. The inner surfaces of the soft wall structure and top flap 216 may be made of vinyl or plastic or any other material which may be relatively easily cleaned. A quick release fitting 39 is affixed to rear wall 214 and allows soother pouch 38 to be affixed to a ring 218 mounted on bag 20. As such, pouch 38 provides an enclosed auxiliary compartment in which a soother can be kept relatively clean and segregated from the contents of bag 20 more generally. Release fitting 39 permits pouch 38 to be removed and washed independently of bag 20.

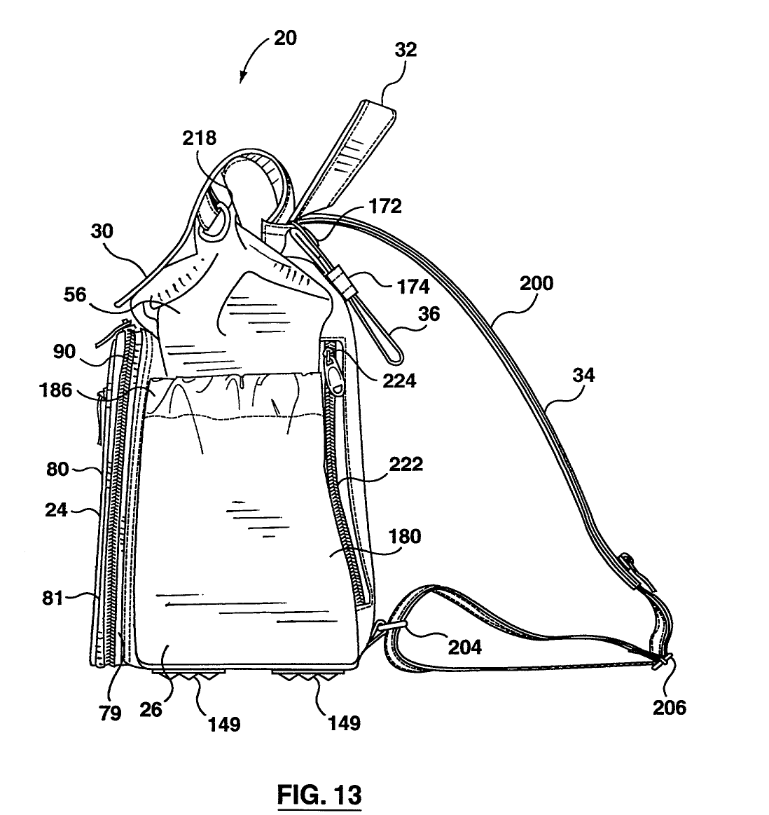

Bag 20 is provided with a further storage compartment identified as pocket 220 and shown in FIGS. 13 and 14. Storage pocket 220 is a flat rectangular pocket (shown in hidden lines on FIG. 14) located within front wall 52. Front wall 52 is made up of a front panel and a rear panel stitched together around the periphery of the panels. Storage pocket 220 lies between the front and rear panel of front wall 52. Storage pocket 220 has an elongated opening 222 lying along the right edge of front wall 52. The lining of storage pocket 220 is made up of two rectangular panels of substantially equal size stitched together along three edges and affixed to either side of opening 222 along their respective fourth edges. The rectangular panels have a height equal to the length of the opening and a depth which generally corresponds to the full width ‘W’ of bag 20. A zipper 224 is used to open and close pocket 220.

As such, the bag illustrated presents the user with a number of options such as may be found convenient. Bag 20 can be carried by top handle 32, like a satchel, or it can be carried on the back in the manner of a knapsack, or it can be carried over one shoulder, or it can be mounted to a bar such as the handle bar of a stroller or a bicycle.

Variations and combinations of the above noted features can be made to the design of the container described above without departing from the invention. The compartments and pockets may be rearranged in a variety of combinations. Although it is preferable to mount the insulated container within the general profile of the main part of the bag, the bottle compartment may be configured to extend only partially within the main compartment or may even be mounted externally to it. Although a high aspect ratio enclosure is preferred (that is, one that is taller than wide or deep), the shape of the insulated bottle compartment may be reconfigured to accommodate containers of other sizes or shapes such as for perishable foods. The zipper configuration for closing the bottle compartment may be replaced by other sealing means, such as hook and loop strips or a zipper extending around the periphery of the compartment. Liner bags 62 and 104 and panels 100 may optionally be formed from materials conducive to easy cleaning and maintenance, such as a vinyl or other plastic material, or may be formed from insulating materials.

Stroller straps 36 can be modified to have the securement fitting, whether a snap, tie or catch mounted at the end of the strap is not affixed to itself, but a portion of the wall structure of bag 20 generally. Stroller straps 36 can also be replaced with a variety of other hanging means. For example, the bag may be provided with straps that end in hooks which can be used to hang the bag from the horizontal cross bar of the stroller.

The invention has now been described in detail. Since changes in and or additions to the above-described best mode may be made without departing from the nature, spirit or scope of the invention, the invention is not to be limited to those details, but only by the appended claims.

I claim:

1. A knapsack comprising:
a soft-sided wall structure having a bottom portion and an upwardly extending wall adjoining said bottom portion, said bottom portion and said upwardly extending wall co-operating to define a chamber therewithin;
said wall structure having an upper region and an opening defined in said upper region by which to obtain access to the chamber;
said upwardly extending wall having a front portion, a rear portion and left and right hand side portions;
said wall structure having a height, a width from left to right, and a front to rear dimension, said width being greater than said front to rear dimension, and said height being greater than said width;
strapping mounted to said front portion to permit the knapsack to be carried on a person's back; and
a receptacle mounted to said wall structure, said receptacle extending at least partially inwardly of one of said side portions relative to said chamber;
said receptacle having an insulated wall member; and
said receptacle having an externally accessible closure member permitting access to objects in said receptacle independently of said opening defined in said upper region of said upwardly extending wall.

2. The knapsack of claim 1 wherein said receptacle has a base, a height measured upwardly from the base, a width, and a depth measured inwardly of the one of said side portions of which the receptacle extends inwardly, said height being greater than either said width or said depth.

3. The knapsack of claim 1 wherein said receptacle lies inwardly of an opening formed in said one of said side portions, and said closure member of said receptacle is a flap movable to a closed position obstructing said opening.

4. The knapsack of claim 2 wherein said closure member is a flap having a lower edge hingedly mounted to said wall structure, and peripheral attachments being operable to mate said flap with said opening in said side portion.

5. The knapsack of claim 1 wherein said receptacle is deformable to permit objects in said chamber to displace portions of said receptacle when said receptacle is unoccupied.

6. The knapsack of claim 1 wherein said wall structure has an enclosure envelope profile, and said receptacle falls within said profile.

7. The knapsack of claim 1 wherein:
said front portion of said upwardly extending wall has an upper margin, a lower margin, a left margin and a right margin;
said strapping includes a pair of first and second straps, each having a first attachment location adjacent to said upper margin of said front portion;
each of said first and second straps has a second attachment in a lower region of said front portion adjacent said left and right hand margins, respectively; and
most of said receptacle lies laterally inboard of one of said lower attachment fittings.

8. The knapsack of claim 1 wherein said rear portion has an auxiliary wall structure mounted thereto, said auxiliary wall structure defining a second chamber therewithin, said auxiliary wall structure having a closure member operable to control access to said second chamber.

9. The knapsack of claim 8 wherein said auxiliary wall structure is a full width structure extending between said left and right hand portions.

10. The knapsack of claim 1 wherein said externally accessible closure member is mounted to one of said side portions of said upwardly extending wall.

11. The knapsack of claim 1 further comprising a washable auxiliary compartment attachable by a quick release fitting to said soft-sided wall structure.

12. A knapsack comprising:
a soft-sided wall structure having a bottom portion and an upwardly extending wall adjoining said bottom portion, said bottom portion and said upwardly extending wall co-operating to define a chamber therewithin;
said wall structure having an upper region and an opening defined in said upper region by which to obtain access to the chamber;
said upwardly extending wall having a front portion, a rear portion and left and right hand side portions;
said wall structure having height, a width from left to right, and a front to rear dimension, said width being greater than said front to rear dimension, and said height being greater than said width;
strapping mounted to said front portion to permit the knapsack to be carried on a person's back; and
an insulated receptacle mounted to said wall structure, said receptacle extending at least partially inwardly of one of said side portions relative to said chamber;
said receptacle having at least one insulated wall member; and
said insulated receptacle having a base, a height measured upwardly from the base, a width, and a depth measured inwardly of the one of said side portions of which the receptacle extends inwardly, said height being greater than either said width or said depth; and
said receptacle having a closure member permitting access to objects in said receptacle structure.

13. A knapsack comprising:
a wall structure having a bottom portion and a sidewall portion standing upwardly of the bottom portion, said sidewall portion and said bottom co-operating to define an internal storage compartment;
said sidewall portion having an opening defined in an upper region thereof by which to obtain access to said internal compartment;
said wall structure having a closure member attached thereto, said closure member being movable to a position obstructing said opening;
said sidewall structure having a leading portion, and a trailing portion;
a pair of first and second straps mounted to said leading portion to facilitate carriage of said knapsack next to a person's back;
said straps each having an upper end mounted to an upper region of said leading portion, and a lower end mounted to a lower region of said leading portion, said upper ends of said respective straps being mounted closer together than said respective lower ends; and
a pair of first and second releasable loops mounted to said upper region of said leading portion, said loops being operable to wrap about an adjacent object, and said loops being securable to permit said knapsack to be suspended therefrom.

14. The knapsack of claim 13 wherein said knapsack includes an insulated receptacle mounted to extend at least partially within said wall structure.

15. The knapsack of claim 14 wherein said sidewall structure has left and right hand side portions, and said insulated receptacle is externally accessible through one of said side portions.

16. The knapsack of claim 14 wherein said insulated receptacle is a side accessible receptacle mounted flush with said sidewall.

17. The knapsack of claim 13 wherein said first and second loops are spaced apart and bracket said upper ends of said straps.

18. The knapsack of claim 13 wherein strap retainers are mounted to said leading portion and said loops are engageable with said strap retainers.

19. The knapsack of claim 13 wherein a connecting member is mounted to releasably connect said first and second straps in a region intermediate said respective upper and lower ends thereof.

20. The knapsack of claim 13 wherein a zipper is mounted along opposed portions of said first and second straps, said zipper being operable to cinch said opposed portions together.

21. The knapsack of claim 13 further comprising an externally mounted detachable wall structure defining an auxiliary chamber.

22. The knapsack of claim 13 further wherein:
said sidewall structure has left and right hand side portions;
an insulated receptacle is mounted to extend within said wall structure, said receptacle being flush mounted with a first of said side portions and being externally accessible through an opening defined in said first side portion;
said first and second loops are spaced apart and bracket said upper ends of said straps; and
a connecting member is mounted releasably to connect said first and second straps in a region intermediate said respective upper and lower ends thereof.

23. A knapsack comprising:
a soft-sided wall structure having a bottom portion and an upwardly extending wall adjoining said bottom portion, said bottom and upwardly extending wall cooperating to define a chamber therewithin;
said wall structure having an upper region and an opening defined in said upper region by which to obtain access to the chamber;
said upwardly extending wall having a front portion, a rear portion and left and right hand side portions;
said wall structure having height, a width from left to right, and a front to rear dimension, said width being greater than said front to rear dimension, and said height being greater than said width;
first strapping mounted to said front portion to permit the knapsack to be carried on a person's back, said first strapping being attached to said front portion at upper and lower locations, said first strapping having at least a minimum length; and
a releasable attachment fitting mounted to said front portion at an upper location, said releasable attachment fitting being operable to permit said releasable attachment fitting to be secured to an adjacent object and suspended therefrom.

24. A knapsack as claimed in claim 23 wherein said releasable attachment fitting includes second strapping.

25. A knapsack as claimed in claim 24 wherein said first strapping has a first length, said second strapping has a second length, said second length being less than said first length.

26. A knapsack as claimed in claim 23 wherein said releasable attachment fitting forms a closed loop.

27. A knapsack as claimed in claim 24 further comprising retainers operable to maintain said second strapping in a stored position when said second strapping is not in use.

28. A knapsack as claimed in claim 23 wherein said first strapping includes a first shoulder strap and a second shoulder strap, said first and second shoulder straps being releasably connected along respective portions thereof.

29. A knapsack as claimed in claim 28 wherein said first strapping has a zipper mounted to releasably connect said respective portions of said first shoulder strap and said second shoulder strap.

30. A knapsack as claimed in claim 23 wherein said front portion has a first panel and a second panel, said first panel being mounted in front of said second panel and a pocket is located between said first and second panels.

31. A knapsack as claimed in claim 30 wherein said pocket is externally accessible.

32. A knapsack as claimed in claim 23 wherein said front portion has a first panel and a second panel, said first panel and said second panel defining a front pocket space therebetween.

33. A knapsack as claimed in claim 33 further comprising a front pocket mounted within said front pocket space, said front pocket being side accessible.

34. A knapsack comprising:
a soft-sided wall structure having a bottom portion and an upwardly extending wall adjoining said bottom portion, said bottom and upwardly extending wall cooperating to define a chamber therewithin;
said wall structure having an upper region and an opening defined in said upper region by which to obtain access to the chamber;
said upwardly extending wall having a front portion, a rear portion and left and right hand side portions;
said wall structure having height, a width from left to right, and a front to rear dimension, said width being greater than said front to rear dimension, and said height being greater than said width;
a releasable loop mounted to said wall structure; and
a carrying member mounted to said wall structure.

35. A knapsack as claimed in claim 34 further comprising first strapping mounted to said front portion to permit the knapsack to be carried on a person's back, said first strapping being attached to said front portion at upper and lower locations, said first strapping having a length and wherein said releasable loop has a length, said length of said releasable loop being less than the length of said first strapping.
